(19) United States
(12) Patent Application Publication
(10) Pub. No.: US 2009/0225970 A1
(43) Pub. Date: Sep. 10, 2009

(54) ENLIVENING CONFERENCE CALLS TO MAKE CONFERENCE CALLS MORE INTERESTING FOR PARTICIPANTS

(75) Inventors: Travis M. Grigsby, Austin, TX (US); Steven Michael Miller, Cary, NC (US); Lisa Anne Seacat, San Francisco, CA (US)

Correspondence Address: IBM CORP. (WSM);c/o WINSTEAD SECHREST & MINICK P.C., P.O. BOX 50784, DALLAS, TX, 75201, US

(73) Assignee: International Business Machines Corporation, Armonk, NY (US)

(21) Appl. No.: 12/044,942

(22) Filed: Mar. 8, 2008

(51) Int. Cl. H04M 3/56

(52) U.S. Cl. 379/202.01

(57) ABSTRACT

A method, system and computer program product for enlivening conference calls. Noise detectors are placed on the telephone lines for the participants to a conference call. These noise detectors are used to monitor for noise on the telephone lines. A pre-selected stored sound (e.g., an interjection such as a laugh) may be generated if there is a period of silence on one of the telephone lines that exceeds a threshold, if noise is detected on a telephone line associated with a pre-selected individual, or if noise is detected on a pre-selected telephone line. Further, a request may be received from one of the participants of the conference call to play a provided interjection. The received interjection is later generated during the conference call. By including interjections during the conference call at appropriate times, the conference call may be enlivened and more interesting to the participants.

### TECHNICAL FIELD

The present invention relates to teleconference systems, and more particularly to enlivening conference calls, such as during periods of a long silence, so as to make the conference calls more interesting for the participants.

### BACKGROUND OF THE INVENTION

Teleconference systems, or simply “conference call systems,” bring multiple parties together from remote locations. Ideally, teleconference systems allow participants to communicate with each other as if they were seated in the same room. A teleconference system includes at least two stations (e.g., mobile telephone, landline telephone) set up in remote rooms or locations interconnected by a transmission system, such as a global network or a telephone system.

Participants at each of the stations communicate with each other through audio equipment. Audio equipment for each station typically includes one or more microphones, speakers, and the like.

Depending on the context of the conference call, the participants of the conference call may experience boredom. As a result, the conference call may exhibit a considerable amount of silence or “dead air” due to the lack of interest from the participants. If interjections (e.g., laugh, cheers, jingles), and the like, could be made during the conference call at times of boredom, the conference call may be enlivened and more interesting to the participants.

### BRIEF SUMMARY OF THE INVENTION

In one embodiment of the present invention, a method for enlivening conference calls comprises establishing a conference call among a plurality of participants. The method further comprises monitoring for a noise on a telephone line for each of the plurality of participants. Additionally, the method comprises generating a pre-selected stored sound in the conference call to enliven the conference call in response to detecting a lack of noise on one of the plurality of telephone lines for a duration of time that exceeds a threshold.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWING

A better understanding of the present invention can be obtained when the following detailed description is considered in conjunction with the following drawings, in which:

FIG. 1 illustrates a teleconference system in accordance with an embodiment of the present invention;

FIG. 2 is a flowchart of a method for establishing a conference call in accordance with an embodiment of the present invention;

FIG. 3 is a flowchart of a method for generating an interjection during a conference call when a lack of noise is detected on a phone line for a duration of time that exceeds a threshold in accordance with an embodiment of the present invention;

FIG. 4 is a flowchart of a method for generating an interjection during a conference call when noise is detected for a pre-selected individual in accordance with an embodiment of the present invention;

FIG. 5 is a flowchart of a method for generating an interjection during a conference call when noise is detected for a pre-selected phone line in accordance with an embodiment of the present invention; and

FIG. 6 is a flowchart of a method for generating an interjection provided by a participant during a conference call in accordance with an embodiment of the present invention.

### DETAILED DESCRIPTION OF THE INVENTION

The present invention comprises a method, system and computer program product for enlivening conference calls. In one embodiment of the present invention, noise detectors are placed on the telephone lines for the participants to a conference call. These noise detectors are used to monitor for noise on the telephone lines. If there is a period of silence on one of the telephone lines that exceeds a threshold, then a pre-selected stored sound (e.g., an interjection such as a laugh) is generated. In one embodiment, if noise is detected on a telephone line associated with a pre-selected individual, then a pre-selected stored sound associated with the pre-selected individual is generated. In another embodiment, if noise is detected on a pre-selected telephone line, then a pre-selected stored sound associated with the pre-selected telephone line is generated. Further, in another embodiment of the present invention, a request is received from one of the participants of the conference call to play a provided interjection. The received interjection is later generated during the conference call. By including interjections during the conference call at appropriate times, the conference call may be enlivened and more interesting to the participants.

While the following discusses the present invention in connection with implementing a conference bridge, the principles of the present invention may be implemented in connection with live streaming or broadcasting over a computer network without the requirement of a conference bridge. A person of ordinary skill in the art would be capable of applying the principles of the present invention to such implementations. Further, embodiments applying the principles of the present invention to such implementations would fall within the scope of the present invention.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

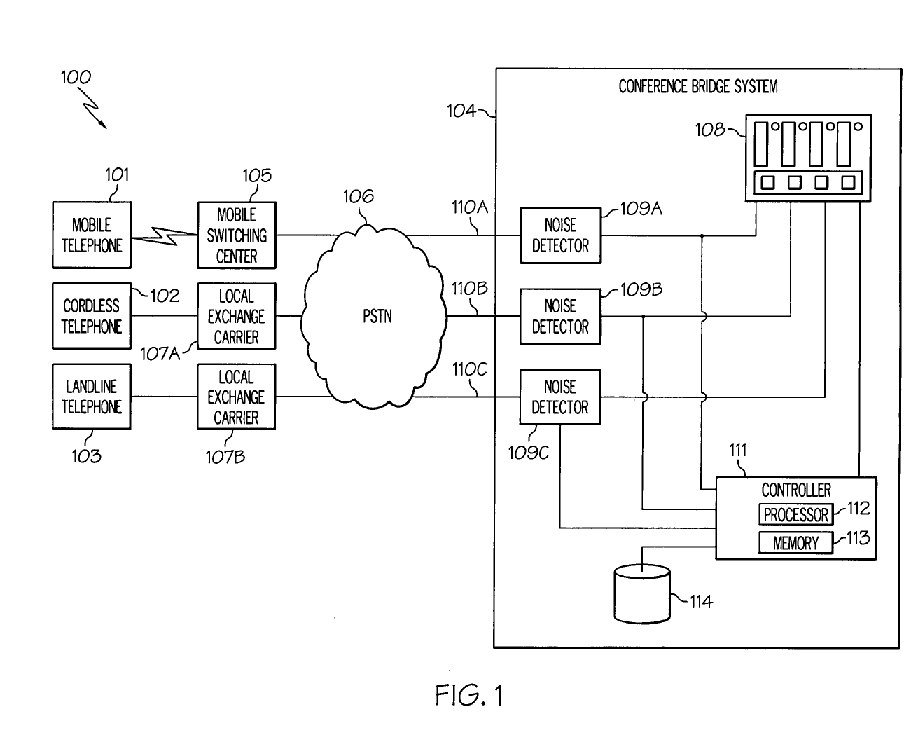

### FIG. 1—Teleconference System

FIG. 1 illustrates an embodiment of the present invention of a teleconference system 100. Teleconference system 100 may include one or more mobile telephones 101, one or more cordless telephones 102 and one or more landline telephones 103.

Mobile telephone 101 may be connected to a conference bridge system 104 via a mobile telephone switching center 105 and a Public Switched Telephone Network (PSTN) 106. Mobile telephone switching center 105 connects the landline Public Switched Telephone Network (PSTN) 106 to the mobile phone system. PSTN 106 may be connected to conference bridge system 104.

Similarly, cordless telephone 102 may be connected to a conference bridge system 104 via a local exchange carrier 107A and PSTN 106. Local exchange carrier 107A enables cordless telephone 102 to gain access to conference bridge system 104 via PSTN 106. Further, landline telephone 103 may be connected to a conference bridge system 104 via a local exchange carrier 107B and PSTN 106. Local exchange carrier 107B enables landline telephone 103 to gain access to conference bridge system 104 via PSTN 106. Local exchange carriers 107A-B may collectively or individually be referred to as local exchange carriers 107 or local exchange carrier 107, respectively.

As stated above, teleconference system 100 may include a conference bridge system 104. Conference bridge system 104 may include a conference bridge 108 configured to connect callers of mobile telephones 101, cordless telephones 102 and landline telephones 103 together, such as on a conference call. Further, conference bridge 108 may be configured to monitor the conference call session as well as electronically balance the lines so that each caller can hear and speak to all the other callers no matter how many people hop on or off the call.

Conference bridge system 104 may further include noise detectors 109A-C configured to monitor and detect noise on the telephone lines 110A-C for mobile telephone 101, cordless telephone 102 and land line telephone 103, respectively. For example, noise detector 109A may monitor and detect noise on telephone line 110A for mobile telephone 101. Noise detector 109B may monitor and detect noise on telephone line 110B for cordless telephone 102. Further, noise detector 109C may monitor and detect noise on telephone line 110C for land line telephone 103. Noise detectors 109A-C may collectively or individually be referred to as noise detectors 109 or noise detector 109, respectively. Further, telephone lines 110A-C may collectively or individually be referred to as telephone lines 110 or telephone line 110, respectively.

Teleconference system 100 may include any number of mobile telephones 101, cordless telephones 102 and land line telephones 103 and therefore may include any number of noise detectors 109 to monitor and detect noise for each phone line. FIG. 1 is illustrative of an embodiment of teleconference system 100 and FIG. 1 is not to be limited in scope to any one particular embodiment. For example, other mobile devices, such as a personal digital assistant, may also be used by a caller to connect with a conference call session. Teleconference system 100 may include any device with the capability of connecting to conference bridge system 104 whether via wire or wirelessly. Each of these devices may be referred to herein as “stations.”

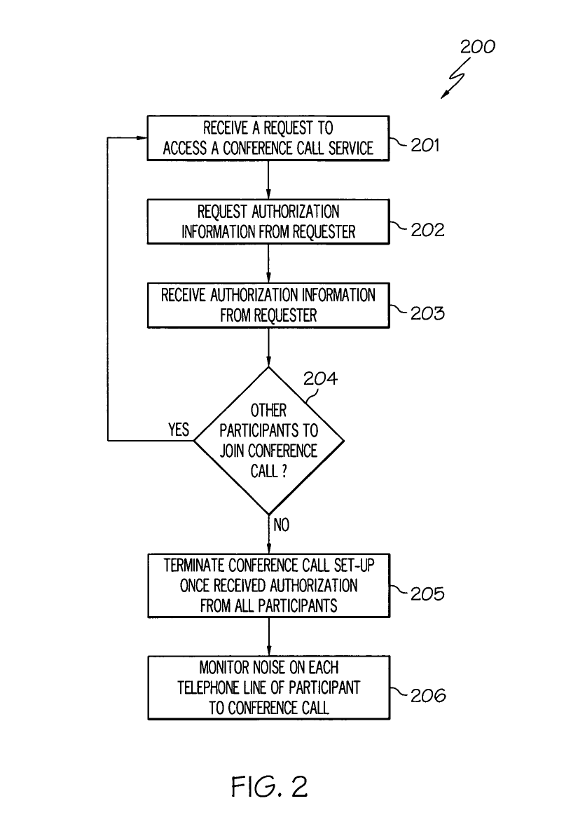

Additionally, conference bridge system 104 may include a controller 111 coupled to conference bridge 108 and to each noise detector 109. Controller 111 is configured to enliven conference calls as discussed herein. Controller 111 may include a processor 112 coupled to a memory 113. Processor 112 may be configured to execute the instructions of the program stored in memory 113. In one embodiment, the program for enlivening conference calls, as discussed further below in connection with FIGS. 2-6, may reside in memory 113. Further, memory 113 may include a program for performing voice analysis to determine if the voice being spoken during the conference call matches a voice profile stored in a database 114 (discussed further below). Additionally, memory 113 may include a program for performing voice recording so as to record an interjection provided by the participant.

The various aspects, features, embodiments or implementations of the invention described herein can be used alone or in various combinations. The methods of the present invention can be implemented by software, hardware or a combination of hardware and software. The present invention can also be embodied as computer readable code on a computer readable medium. The computer readable medium is any data storage device that can store data which can thereafter be read by a computer system. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

Referring to FIG. 1, conference bridge system 104 may further include a database 114 coupled to controller 111. Database 114 may be used to store interjections (e.g., laugh, music, jingles, cheers, jeers, applause, explosion, fireworks, echo, reverberation, voice pitch alteration, repeating, etc.,) that are used to enliven a conference call as discussed further below. Further, database 114 may be used to store voice profiles of individuals which are used by controller 111 to determine if a particular individual is speaking during the conference call.

As discussed in the Background section, the participants of a conference call may experience boredom. As a result, the conference call may exhibit a considerable amount of silence or “dead air” due to the lack of interest from the participants. If interjections (e.g., laugh, cheers, jingles), and the like, could be made during the conference call at times of boredom, the conference call may be enlivened and more interesting to the participants.

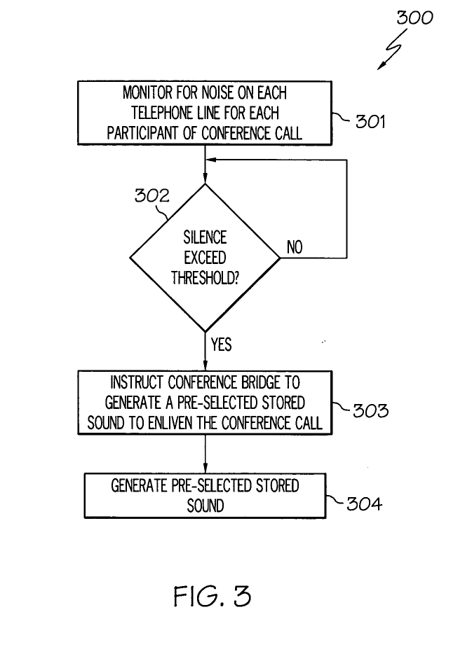

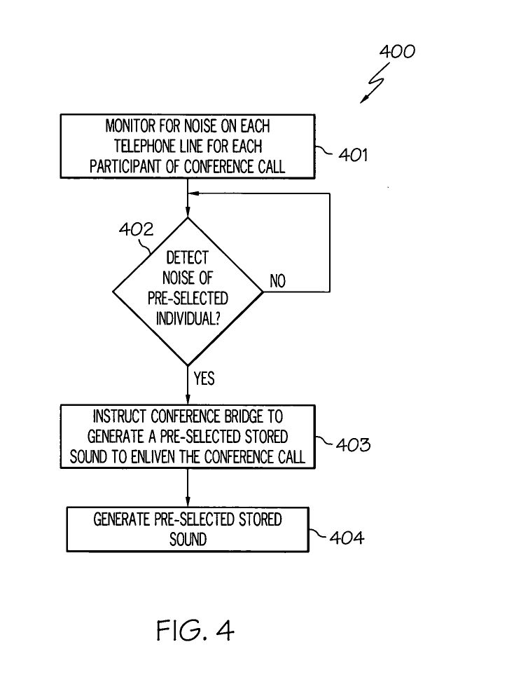

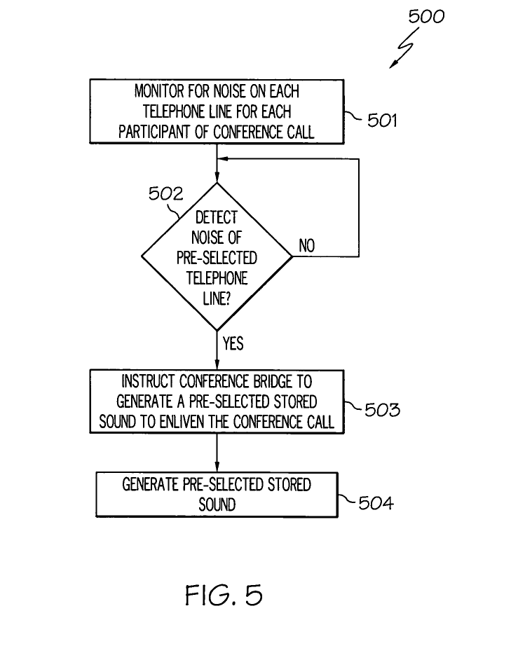

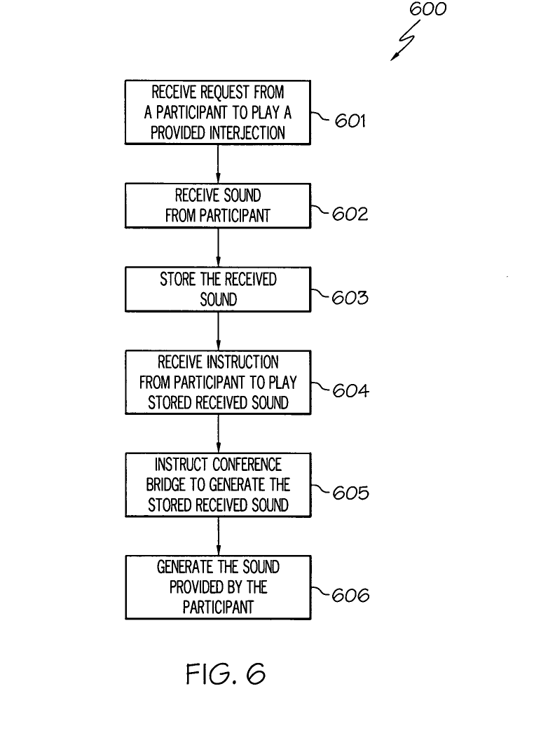

Interjections may be generated during the conference call to enliven the conference call as discussed below in connection with FIGS. 2-6. FIG. 2 is a flowchart of a method for setting up a conference call among the participants. FIG. 3 is a flowchart of a method for generating an interjection during the conference call when a lack of noise is detected on a phone line for a duration of time that exceeds a threshold. FIG. 4 is a flowchart of a method for generating an interjection during the conference call when noise is detected for a pre-selected individual (e.g., particular participant). FIG. 5 is a flowchart of a method for generating an interjection during the conference call when noise is detected for a pre-selected phone line (e.g., caller on a particular line starts speaking). FIG. 6 is a flowchart of a method for generating an interjection provided by a participant (e.g., moderator) during the conference call.

### FIG. 2—Method for Establishing Conference Call

FIG. 2 is a flowchart of a method 200 for establishing a conference call in accordance with an embodiment of the present invention.

Referring to FIG. 2, in conjunction with FIG. 1, in step 201, controller 111 receives a request from a participant (e.g., user of mobile phone 101) to access a conference call service. For example, the participant may dial a particular “800” number to gain access to the conference call service.

In step 202, controller 111 requests authorization information from the requestor. For example, controller 111 may request a pass code to be entered by the participant on the telephone keypad in order to obtain access to the conference call service. The pass code may have been previously provided to those participants that are authorized to join the conference call by the moderator of the conference call.

In step 203, controller 111 receives the authorization information from the requestor.

In step 204, controller determines whether there are any other participants to join the conference call. If there are other participants to join the conference call, then, controller 111 waits to receive a request from the next participant to join the conference call session in step 201.

If, however, there are no other participants to join the conference call, then, in step 205, controller 111 terminates the conference call set-up.

In step 206, noise detectors 109 monitors for noise on each of the telephone lines (e.g., telephone lines 109A-C) for each participant (e.g., user of mobile phone 101, user of cordless telephone 102, user of landline telephone 103) to the conference call.

It is noted that the conference call may begin prior to each participant joining the conference call and that noise detectors 109 may begin monitoring for noise on phone lines 110 for those participants that have joined the conference call prior to each participant joining the conference call. In one embodiment, the conference call may begin upon the moderator joining the conference call.

Method 200 may include other and/or additional steps that, for clarity, are not depicted. Further, method 200 may be executed in a different order presented and that the order presented in the discussion of FIG. 2 is illustrative. Additionally, certain steps in method 200 may be executed in a substantially simultaneous manner or may be omitted.

A discussion of generating an interjection during the conference call when a lack of noise is detected on a phone line for a duration of time that exceeds a threshold is provided below in connection with FIG. 3.

FIG. 3—Method for Generating an Interjection During Conference Call when Lack of Noise is Detected for a Duration of Time that Exceeds Threshold

FIG. 3 is a flowchart of a method 300 for generating an interjection during a conference call when a lack of noise is detected on a phone line for a duration of time that exceeds a threshold in accordance with an embodiment of the present invention.

Referring to FIG. 3, in conjunction with FIG. 1, in step 301, noise detectors 109 monitor for noise on each telephone line 110 for each of the participants of the conference call. For example, noise detectors 109 may monitor for noise on telephone lines 110A-C.

In step 302, controller 111 determines whether noise detector 109 detected a lack of noise (“dead air”) on one of the telephone lines 110 for the participants of the conference call that exceeds a threshold (e.g., five minutes).

If noise detectors 109 do not detect a lack of noise on one of the telephone lines 110 for the participants of the conference call that exceeds a threshold, then, in step 301, noise detectors 109 continue to monitor for noise on each telephone line 110 for each of the participants of the conference call.

If, however, noise detector 109 detects a lack of noise on one of the telephone lines 110 for the participants of the conference call that exceeds a threshold, then, in step 303, controller 111 instructs conference bridge 108 to generate a pre-selected stored sound to enliven the conference call. Interjections, such as a laugh, music, jingles, cheers, jeers, applause, explosion, fireworks, echo, reverberation, voice pitch alteration, repeating, etc., may be stored in database 114. The moderator of the conference call may pre-select which interjection to play when dead air is detected on a phone line that exceeds a threshold. For example, the moderator may be prompted by controller 111 (via conference bridge 108) upon joining the conference call to select a particular interjection which may be identified by a particular number entered by the moderator on the telephone keypad. Further, in one embodiment, the threshold is pre-selected by the moderator. For example, the moderator may be prompted by controller 111 (via conference bridge 108) upon joining the conference call to select a threshold, such as by selecting number(s) on the telephone keypad.

In step 304, conference bridge 108 generates the pre-selected stored sound to enliven the conference call.

Method 300 may include other and/or additional steps that, for clarity, are not depicted. Further, method 300 may be executed in a different order presented and that the order presented in the discussion of FIG. 3 is illustrative. Additionally, certain steps in method 300 may be executed in a substantially simultaneous manner or may be omitted.

A discussion of generating an interjection during the conference call when noise is detected for a pre-selected individual (e.g., particular participant of the conference call) is provided below in connection with FIG. 4.

FIG. 4—Method for Generating an Interjection During Conference Call when Noise is Detected for a Pre-Selected Individual

FIG. 4 is a flowchart of a method 400 for generating an interjection during a conference call when noise is detected for a pre-selected individual (e.g., particular participant of the conference call) in accordance with an embodiment of the present invention.

Referring to FIG. 4, in conjunction with FIG. 1, in step 401, noise detectors 109 monitor for noise on each telephone line 110 for each of the participants of the conference call. For example, noise detectors 109 may monitor for noise on telephone lines 110A-C.

In step 402, controller 111 determines whether a noise is detected from a pre-selected individual (e.g., participant of the conference call). In one embodiment, a voice profile of an indicated individual, along with contact information for that individual (e.g., name, phone number), may be provided to controller 111 from a participant of the conference call (e.g., moderator). For example, the moderator may provide to controller 111 a voice profile of a particular individual (e.g., one of the participants of the conference call). Further, the moderator may provide contact information, such as name and phone number, for that individual. The voice profile of an individual along with the associated contact information may be stored in database 114 of controller 111. For example, database 114 may store an array of voice profiles and associated contact information. Controller 111 may include a program stored in memory 113 configured to perform voice analysis to determine if the voice being spoken during the conference call matches a voice profile stored in database 114. In one embodiment, the voice analysis software in controller 111 may compare the voice detected by noise detector 109 with the voice profiles stored in database 114.

If controller 111 does not detect a noise of a pre-selected individual, then, in step 401, noise detectors 109 continue to monitor for noise on each telephone line 110 for each of the participants of the conference call.

If, however, controller 111 detects a noise of a pre-selected individual, then, in step 403, controller 111 instructs conference bridge 108 to generate a pre-selected stored sound associated with the identified individual to enliven the conference call. Interjections, such as a laugh, music, jingles, cheers, jeers, applause, explosion, fireworks, echo, reverberation, voice pitch alteration, repeating, etc., may be stored in database 114. For example, the moderator may be prompted by controller 111 (via conference bridge 108) upon joining the conference call to select a particular interjection to play upon detecting the voice of an identified participant. The moderator may identify the particular interjection to be played by entering an appropriate number on the telephone keypad. Further, upon joining the conference call, the participant (e.g., moderator) may identify the participant, of whose voice profile should be used, by entering an appropriate number on the telephone keypad. For example, the moderator may enter the phone number of the participant, whose voice profile should be used, on the telephone keypad. Controller 111 may match that phone number with one of the phone numbers stored in database 114 that is associated with a particular voice profile. Upon finding a match, controller 111 will then know the interjection to be played upon identifying the voice that matches that voice profile.

In step 404, conference bridge 108 generates the pre-selected stored sound to enliven the conference call.

Method 400 may include other and/or additional steps that, for clarity, are not depicted. Further, method 400 may be executed in a different order presented and that the order presented in the discussion of FIG. 4 is illustrative. Additionally, certain steps in method 400 may be executed in a substantially simultaneous manner or may be omitted.

A discussion of generating an interjection during the conference call when noise is detected for a pre-selected phone line (e.g., caller on a particular line starts speaking) is provided below in connection with FIG. 5.

FIG. 5—Method for Generating an Interjection During Conference Call when Noise is Detected for a Pre-Selected Phone Line

FIG. 5 is a flowchart of a method 500 for generating an interjection during a conference call when noise is detected for a pre-selected phone line (e.g., caller on a particular line starts speaking) in accordance with an embodiment of the present invention.

Referring to FIG. 5, in conjunction with FIG. 1, in step 501, noise detectors 109 monitor for noise on each telephone line 110 for each of the participants of the conference call. For example, noise detectors 109 may monitor for noise on telephone lines 110A-C.

In step 502, controller 111 determines whether a noise is detected from a pre-selected phone line (e.g., participant of mobile telephone 101).

If controller 111 does not detect a noise on a pre-selected phone line, then, in step 501, noise detectors 109 continue to monitor for noise on each telephone line 110 for each of the participants of the conference call.

If, however, controller 111 detects a noise on a pre-selected phone line, then, in step 403, controller 111 instructs conference bridge 108 to generate a pre-selected stored sound associated with that phone line to enliven the conference call. Interjections, such as a laugh, music, jingles, cheers, jeers, applause, explosion, fireworks, echo, reverberation, voice pitch alteration, repeating, etc., may be stored in database 114. For example, the moderator may be prompted by controller 111 (via conference bridge 108) upon joining the conference call to select a particular interjection to play upon detecting noise on an identified phone line. The moderator may identify the particular interjection to be played by entering an appropriate number on the telephone keypad. Further, upon joining the conference call, the participant (e.g., moderator) may identify the phone line to be used. For example, the moderator may enter the phone number of the participant whose phone line is to be used on the telephone keypad.

In step 504, conference bridge 108 generates the pre-selected stored sound to enliven the conference call.

Method 500 may include other and/or additional steps that, for clarity, are not depicted. Further, method 500 may be executed in a different order presented and that the order presented in the discussion of FIG. 5 is illustrative. Additionally, certain steps in method 500 may be executed in a substantially simultaneous manner or may be omitted.

A discussion of generating an interjection provided by a participant (e.g., moderator) during the conference call is provided below in connection with FIG. 6. An interjection may be provided by a participant at any time during the conference call, even without there being dead air. The interjection may then be played during the conference call upon an indication from the participant. For example, the participant may indicate to play laughter, which it previously provided to controller 111, after telling a joke.

### FIG. 6—Method for Generating an Interjection Provided by a Participant During Conference Call

FIG. 6 is a flowchart of a method 600 for generating an interjection provided by a participant (e.g., moderator) during a conference call in accordance with an embodiment of the present invention.

Referring to FIG. 6, in conjunction with FIG. 1, in step 601, controller 111 receives a request from a participant (e.g., moderator) of the conference call to play a provided interjection. In one embodiment, the participant may be prompted by controller 111 (via conference bridge 108) as to whether it wishes to provide an interjection to be played during the conference call. The participant may indicate, via the telephone keypad, the desire to input an interjection that is to be played during the conference call. In one embodiment, the participant may play the interjection (e.g., laugh) over the telephone and have it recorded by controller 111. In one embodiment, controller 111 may include a program stored in memory 113 configured to record sound. Controller 111 may record the interjection provided by the participant and store it in database 114. It is noted that the sound provided by the participant to be played during a conference call may be added by the participant at any time before or during the conference call.

In step 602, controller 111 receives a sound from the participant. As discussed above, in one embodiment, the participant may play an interjection to be recorded by controller 111. In step 603, controller 111 stores the received sound in database 114 as discussed above.

In step 604, controller 111 receives an instruction from the participant, such as during the conference call, to play the stored received sound. For example, in one embodiment, the participant selects a button the telephone keypad indicating the participant's desire to play the stored received sound. For instance, the participant may select a button to play the stored sound of laughter after telling a joke.

In step 605, controller 111 instructs conference bridge 108 to generate the stored received sound.

In step 606, conference bridge 108 generates the sound provided by the participant to enliven the conference call.

Method 600 may include other and/or additional steps that, for clarity, are not depicted. Further, method 600 may be executed in a different order presented and that the order presented in the discussion of FIG. 6 is illustrative. Additionally, certain steps in method 600 may be executed in a substantially simultaneous manner or may be omitted.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for enlivening conference calls, the method comprising:
establishing a conference call among a plurality of participants;
monitoring for a noise on a telephone line for each of said plurality of participants; and
generating a pre-selected stored sound in said conference call to enliven said conference call in response to detecting a lack of noise on one of said plurality of telephone lines for a duration of time that exceeds a threshold.

2. The method as recited in claim 1 further comprising:
detecting a noise on one of said plurality of telephone lines associated with a pre-selected individual; and
generating a pre-selected stored sound associated with said pre-selected individual in response to detecting said noise associated with said pre-selected individual.

3. The method as recited in claim 1 further comprising:
detecting a noise on a pre-selected telephone line; and
generating a pre-selected stored sound associated with said pre-selected telephone line in response to detecting said noise on said pre-selected telephone line.

4. The method as recited in claim 1 further comprising:
receiving a request from one of said plurality of participants to play an inputted sound;
storing said inputted sound; and
generating said inputted sound.

5. The method as recited in claim 1 further comprising:
receiving a request from a web application to play an inputted sound;
storing said inputted sound; and
generating said inputted sound.

6. A system, comprising:
a controller coupled to a plurality of noise detectors, wherein each of said plurality of noise detectors monitors for a noise on a telephone line for one of a plurality of stations, wherein said controller comprises:
a memory unit for storing a computer program for enlivening conference calls; and
a processor coupled to said memory unit, wherein said processor, responsive to said computer program, comprises:
circuitry for establishing a conference call among said plurality of stations; and
circuitry for instructing to generate a pre-selected stored sound in said conference call to enliven said conference call in response to detecting a lack of noise on one of said plurality of telephone lines for a duration of time that exceeds a threshold.

7. The system as recited in claim 6, wherein one of said plurality of noise detectors detects a noise associated with a pre-selected individual, wherein said processor further comprises:
circuitry for instructing to generate a pre-selected stored sound associated with said pre-selected individual in response to detecting said noise associated with said pre-selected individual.

8. The system as recited in claim 6, wherein one of said plurality of noise detectors detects a noise associated with a pre-selected telephone line, wherein said processor further comprises:
circuitry for instructing to generate a pre-selected stored sound associated with 5 said pre-selected telephone line in response to detecting said noise associated with said pre-selected telephone line.

9. The system as recited in claim 6, wherein said processor further comprises:
circuitry for receiving a request from a participant of one of said plurality of stations to play an inputted sound;
circuitry for storing said inputted sound; and
circuitry for instructing to generate said inputted sound.

10. The system as recited in claim 6, wherein said processor further comprises:
circuitry for receiving a request from a web application to play an inputted sound;
circuitry for storing said inputted sound; and
circuitry for instructing to generate said inputted sound.

11. The system as recited in claim 6, wherein said plurality of stations comprises one or more of the following: a mobile telephone, a cordless telephone, a personal digital assistant, and a landline telephone.

12. The system as recited in claim 6 further comprising:
a conference bridge coupled to said controller, wherein said conference bridge is configured to connect callers of said plurality of stations together.

13. A computer program product embodied in a computer readable medium for enlivening conference calls, the computer program product comprising the programming instructions for:
establishing a conference call among a plurality of participants, wherein each of a plurality of noise detectors monitors for a noise on a telephone line for one of said plurality of participants; and
instructing to generate a pre-selected stored sound in said conference call to enliven said conference call in response to detecting a lack of noise on one of said plurality of telephone lines for a duration of time that exceeds a threshold.

14. The computer program product as recited in claim 13, wherein one of said plurality of noise detectors detects a noise associated with a pre-selected individual, wherein the computer program product further comprises programming instructions for:
instructing to generate a pre-selected stored sound associated with said pre-selected individual in response to detecting said noise associated with said pre-selected individual.

15. The computer program product as recited in claim 13, wherein one of said plurality of noise detectors detects a noise associated with a pre-selected telephone line, wherein the computer program product further comprises programming instructions for:
instructing to generate a pre-selected stored sound associated with said pre-selected telephone line in response to detecting said noise associated with said pre-selected telephone line.

16. The computer program product as recited in claim 13 further comprising the programming instructions for:
receiving a request from one of a plurality of participants to play an inputted sound;
storing said inputted sound; and
instructing to generate said inputted sound.

17. The computer program product as recited in claim 16 further comprising the programming instructions for:
receiving a request from a web application to play an inputted sound;
storing said inputted sound; and
instructing to generate said inputted sound.

18. A method for enlivening conference calls, the method comprising:
receiving a sound;
storing said received sound;
receiving a request during a conference call to play said received sound; and
generating said stored received sound.
